(19) United States
(12) Patent Application Publication
(10) Pub. No.: US 2023/0177904 A1
(43) Pub. Date: Jun. 8, 2023

(54) Distributed Smart Locker System

(71) Applicant: BOXIE INC., Miami Shores, FL (US)

(72) Inventors: Daniel Galano, Miramar, FL (US); Arian Acosta, Boston, MA (US); Lemay Sanchez, Miami Shores, FL (US); Pedro Machin, Miramar, FL (US)

(21) Appl. No.: 17/543,281

(22) Filed: Dec. 6, 2021

(51) Int. Cl. G07C 9/00; G07F 17/12; G07F 9/00; G07F 9/02

(52) U.S. Cl. CPC G07C 9/00912; G07F 17/13; G07F 9/006; G07F 9/009; G07F 9/0235

(57) ABSTRACT

A distributed smart locker system includes a plurality of locker units in a locker cluster. Each locker unit includes: a front panel with a set of inputs for an end user to retrieve an at least one item stored in the locker unit; a back panel with a set of outputs for an operator to place the at least one item in the locker unit; and a computing device with a processor, memory, storage, and wireless networking capability.

### CROSS-REFERENCE TO RELATED APPLICATIONS

None.

### FIELD OF THE INVENTION

The present invention generally relates to a distributed system of locker units and more specifically relates to a distributed smart locker system where each locker unit has a computing device and a set of inputs and outputs.

### BACKGROUND OF THE INVENTION

The online ordering of food and other goods has grown tremendously in the past decade. Users expect local businesses to offer online ordering.

This has created a challenge for restaurants and stores to be able to properly organize all the items that are ordered online for pickup. Today, the most common method used is putting food orders on a shelf or table with some type of name tag so that they can be identified. In this case, the final customer or delivery person has to go through every package to identify theirs. Another method is to keep the items behind a counter which requires the final customer or delivery person to interact with the operator to get the package. These methods are inefficient and cumbersome for both the operators and the customers.

A variety of smart locker systems exists today. Some of them are described in US20150186840A1 (TORRES), US20030025590A1 (Gokcebay), US20020156645A1 (Hansen), and U.S. Ser. No. 10/997,548B2 (NELSON). All of these systems consist of a series of locker units that connect to a central station or computing device that controls all of them, connects to the internet, and interacts with the user. These locker units do not have any computing system in them and all depend on the central station to operate. In most cases, these smart locker vendors sell a locker cabinet with a given amount of locker units already configured and pre-built, with no option to add or remove a locker unit as needed.

With these systems, the operators have the challenge to install, configure and grow the system as the business needs change. They must predict in advance how many units will be needing. Also if the central station breaks all the locker units become non-operational. For the end user picking up, these systems are also not ideal because a line can form at the central station since every user must use it to open their assigned locker (does not allow multiple users to open the lockers at the same time).

There exists, therefore, a need for a system and method, that does not suffer from the aforementioned problems.

### SUMMARY OF THE INVENTION

The present invention advantageously fills the aforementioned deficiencies by providing a distributed set of locker units storing items to be picked up by end users. The locker units can be distributed in any desired configuration, around a restaurant, store, university, apartment building, or any other physical location, for an item to be picked up by a user.

Briefly, according to an embodiment of the invention, each locker unit can be directly powered from the wall electrical outlet or can be attached to another locker unit from any side to form a locker cluster and to get power from that linkage. Each locker unit does not depend on any other external/centralized station or controller system to be fully functional. Each locker unit contains a computing device with a processor, memory, storage, wireless networking (e.g. WiFi, Bluetooth), and a set of inputs and outputs for the user to retrieve the item and for the operator to place the item.

The present invention now will be described more fully hereinafter with reference to the accompanying drawings, which are intended to be read in conjunction with both this summary, the detailed description and any preferred and/or particular embodiments specifically discussed or otherwise disclosed, as well as, the appended claims. This invention may, however, be embodied in many different forms and should not be construed as limited to the embodiments set forth herein; rather, these embodiments are provided by way-of illustration only and so that this disclosure will be thorough, complete and will fully convey the full scope of the invention to those skilled in the art.

### BRIEF DESCRIPTION OF THE DRAWINGS

In the accompanying figures, like reference numerals refer to identical or functionally similar elements throughout the separate views. The accompanying figures, together with the detailed description below are incorporated in and form part of the specification and serve to further illustrate various embodiments and to explain various principles and advantages all in accordance with the present invention, in which:

FIG. 1 illustrates an exemplary locker cluster composed of eleven locker units, according to an embodiment;

FIG. 2 illustrates an exemplary block diagram of an exemplary control system of a locker unit, according to an embodiment;

FIG. 3 illustrates an exemplary locker interlocking mechanism used to assemble a group of four locker units in a cluster and transmit power among them, according to an embodiment;

FIG. 4 illustrates an exemplary locker interlocking mechanism after being assembled in a group of four locker units in a cluster, according to an embodiment;

FIG. 5 illustrates an exemplary locker interconnect mechanism used to assemble a group of two locker units in a cluster and transmit power between them, according to an embodiment;

FIG. 6 illustrates an exemplary locker interconnect mechanism after being assembled in a group of four locker units in a cluster, according to an embodiment;

FIG. 7 illustrates an exemplary locker interconnect mechanism that is used to power the locker unit from a wall electrical outlet, according to an embodiment;

FIG. 8 illustrates an exemplary cloud control software that controls all the locker units, according to an embodiment;

FIG. 9 illustrates an exemplary timeline of how a locker cluster of three lockers is constructed, according to an embodiment;

FIG. 10 illustrates an exemplary locker cluster of six units arranged on a table counter, according to an embodiment;

FIG. 11 illustrates an exemplary locker cluster of six units arranged in two columns against a wall, according to an embodiment;

FIG. 12 illustrates an exemplary locker cluster composed of locker units of different dimensions, according to an embodiment;

FIG. 13 illustrates an exemplary locker unit viewed from the front with the major components highlighted, according to an embodiment;

FIG. 14 illustrates an exemplary locker unit viewed from the back with the major components highlighted, according to an embodiment;

FIG. 15 illustrates a screenshot of an exemplary user interface of the front display, according to an embodiment;

FIG. 16 illustrates a screenshot of an exemplary user interface of the back display, according to an embodiment; and

FIG. 17 illustrates an exemplary table with the different combinations of the information displayed to the user on the locker unit's display and the challenge presented to the user for the different combinations of data available from the order, according to an embodiment.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

The following detailed description illustrates implementations of the subject matter described in this application by way of example and not by way of limitation. It should be understood that the drawings are diagrammatic and schematic representations of exemplary embodiments of the invention, and are not limiting of the present invention nor are they necessarily drawn to scale.

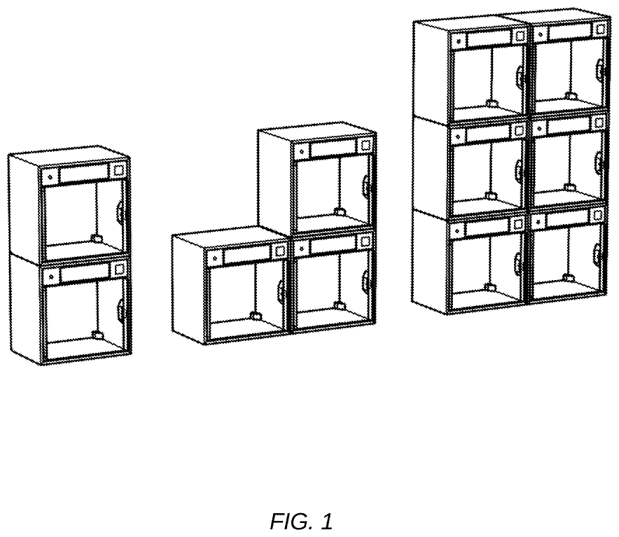

Disclosed here is a distributed smart locker system that can be used in a variety of places like restaurants, stores, universities, shopping malls, apartment buildings, or any other physical location. FIG. 1 shows an exemplary distributed locker system composed of eleven locker units.

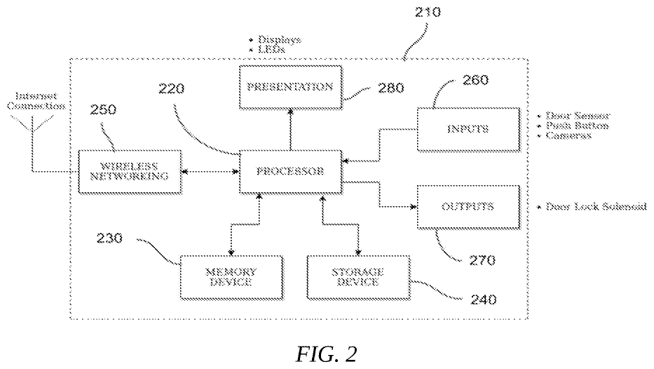

FIG. 2 shows an exemplary block diagram of a computing device 210 that may be used inside each locker unit. The computing device may consist of a processor 220, memory 230, storage 240, wireless networking 250 (e.g. WiFi, Bluetooth), and a set of inputs 260 and outputs 270 together with a presentation layer 280 for the operator to place an item and for the user to retrieve it.

Each locker unit has two ways of being powered. The first way is by connecting it to a power supply to an electrical outlet. In this configuration, the locker unit becomes a power source and can distribute the power to other locker units in the locker cluster. The second way of being powered is by attaching to a power source locker unit or by attaching to another unit in the locker cluster. In this configuration, the locker units become a power link. Every locker unit can act as a power source or a power link. This allows the operator to add and remove locker units as desired, and also to place them in any configuration for the given location. Each locker unit can be of various sizes and are still interconnectable to one another.

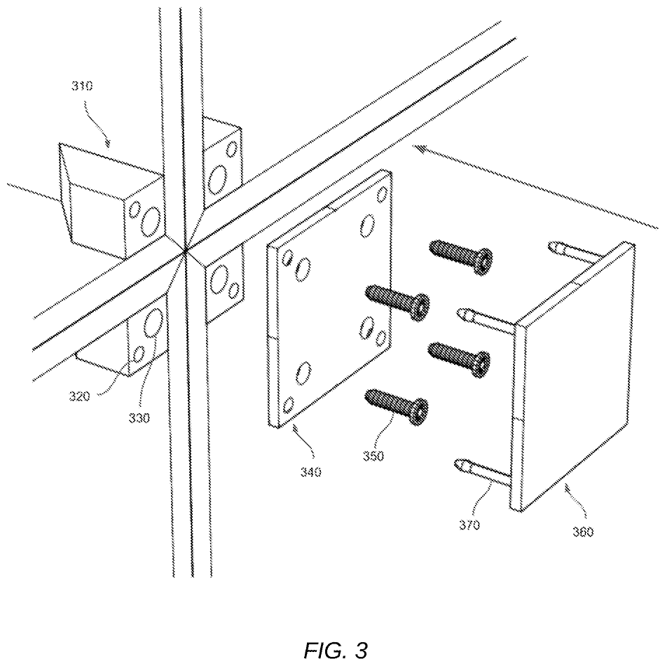

FIG. 3 shows an exemplary interlocking mechanism used to connect four locker units together. Each locker unit has four anchor points 310 in each corner in the back that can receive power or provide power from neighboring locker units. Each anchor point has a positive 320 and negative 330 terminals. The first step to assemble the locker units is to connect a metallic plate 340 that serves for both mechanical and electrical connections. This metallic plate connects all the negative terminals 330 of the anchor points via screws 350 that also serve for mechanical fastening. After all the screws are tightened, another plate 360 with four prongs 370 is used to interconnect the positive terminals 320.

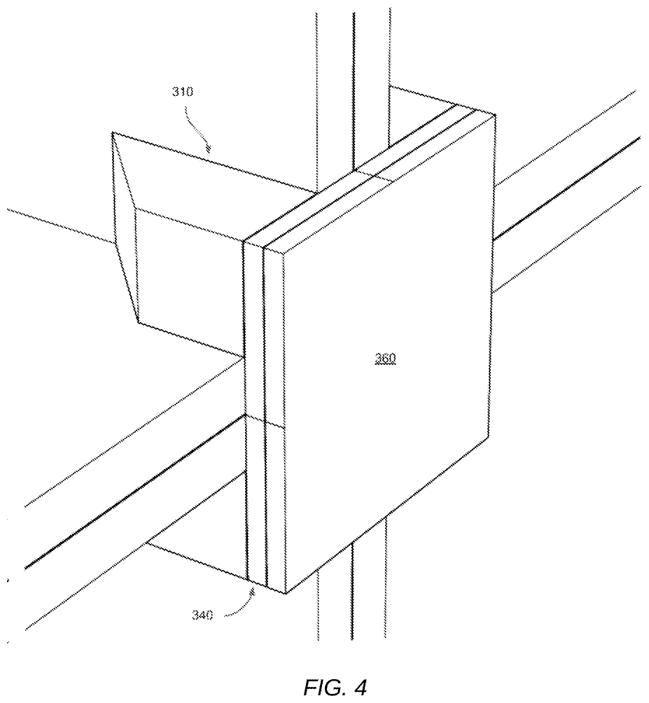

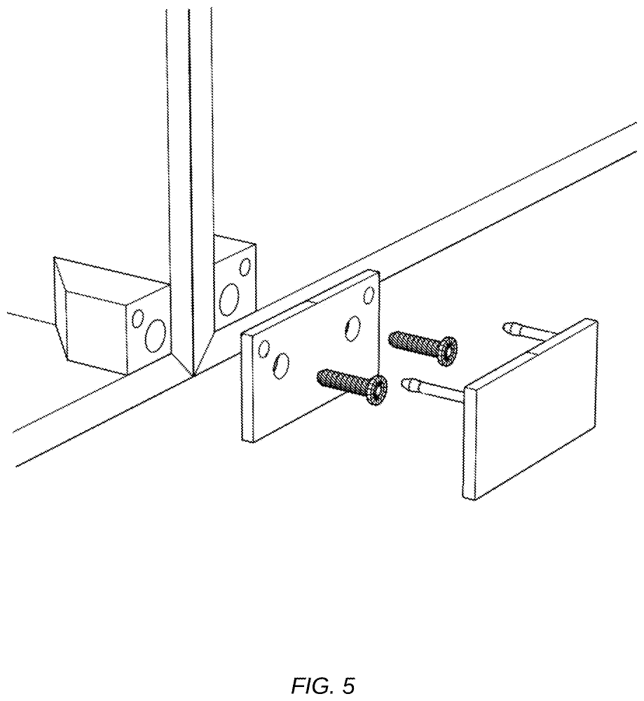

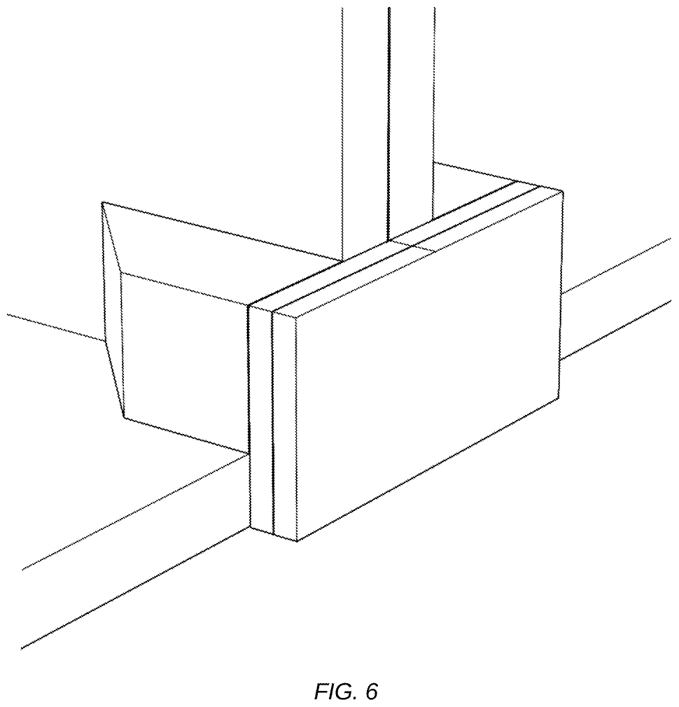

FIG. 3 is an exploded view of the interlocking mechanism before assembly and FIG. 4 shows after assembly. FIG. 5 and FIG. 6 show the same for when only two locker units are being connected (either horizontally or vertically). By combining these interlocking mechanisms the user can assemble a locker cluster in any configuration desired. These interconnecting mechanisms can be used to transmit power through all the power link locker units from the power source locker unit connected to a wall power outlet.

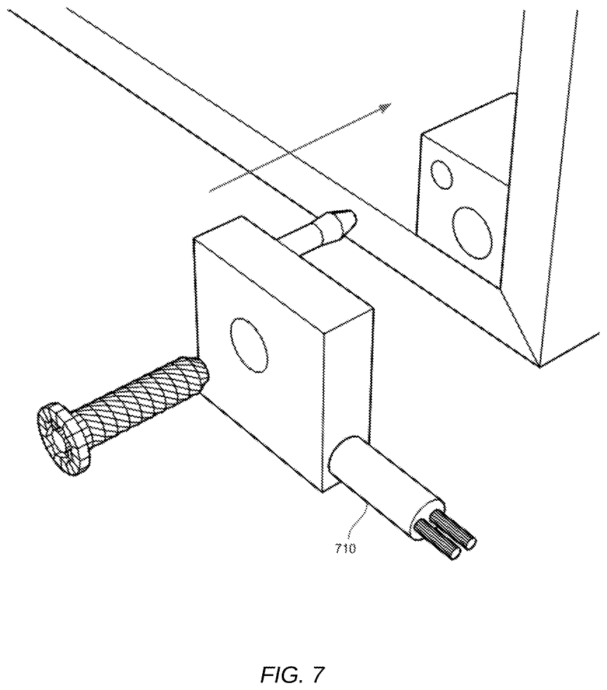

To provide electricity to the power source, a special interlocking mechanism is used that only attaches to one anchor point in the power source locker unit. FIG. 7 shows this special interlocking mechanism with the cable 710 that goes to a power supply which connects to the wall electrical outlet. Each locker unit can connect to the internet and is fully configurable for each location to operate on its own or as a group. The configuration of each locker unit is managed by the cloud control software 810.

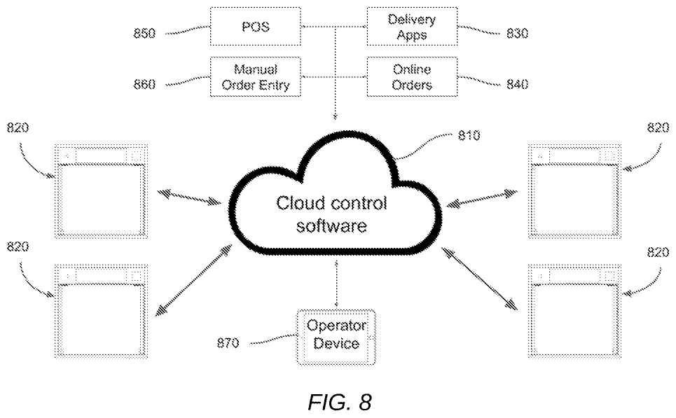

FIG. 8 shows an exemplary cloud control software 810, which manages each locker 820 unit and controls what information about the order is sent to each locker unit for display. It also manages the security of verifying the user opening the locker. The cloud control software receives order information from different sources like delivery apps 830, webpage 840, POS systems 850, or manual order entry 860. The operator interacts with the cloud control software using a device 870 such as a smartphone, tablet, or PC. This operator device 870 is used to configure the locker cluster initially or as new locker units are added, but is not required for day-to-day operation.

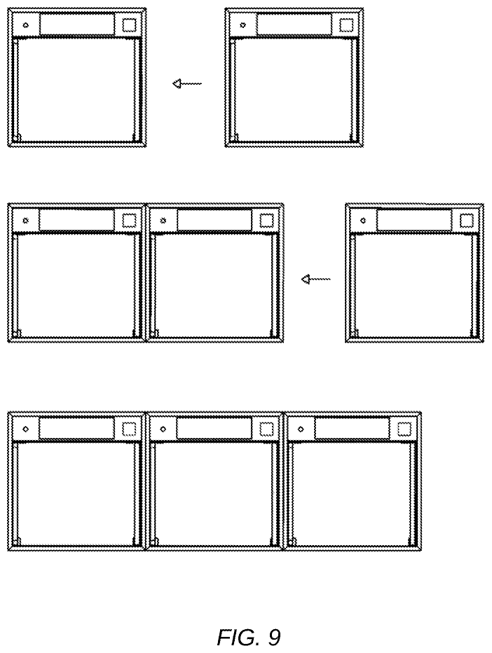

FIG. 9 shows an exemplary timeline, where an operator could begin with one locker unit connected to the wall electrical outlet (acting as power source). This unit by itself is fully functional and allows one order at a time to be placed in the locker unit. Later on, a second unit (power link) can be added to the side of the power source by connecting the interlocking mechanism of FIG. 5, and now two orders can be placed in the locker cluster simultaneously. Later on, a third locker unit can be installed to the side of the second unit creating a cluster of three. As units are added, the operator only needs to configure the units using the cloud control software 810.

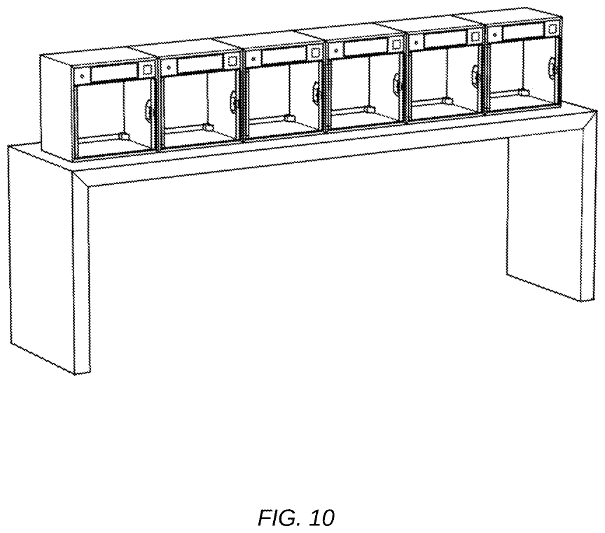

FIG. 10 shows an exemplary embodiment, where an operator could place six locker units horizontally in a table counter with the back facing the kitchen.

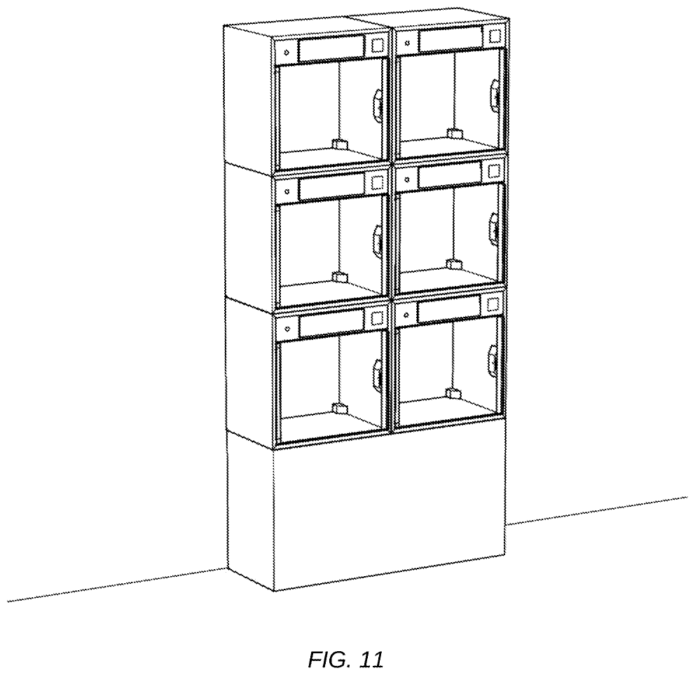

FIG. 11 shows an exemplary embodiment, where an operator could place six locker units vertically in two columns next to the restaurant entrance.

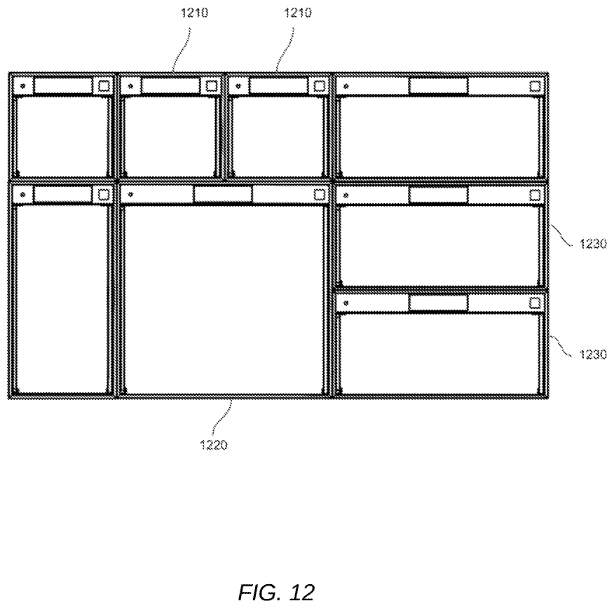

In all cases, each locker unit used to build the cluster is fully independent and of any given size, and the cluster can be dynamically configured. FIG. 12 shows an example of a cluster configuration with different locker unit sizes. Each locker unit has dimensions that are a multiple of a base size. In this example, three locker units 1210 are half the width of locker unit 1220. The same way locker units 1230 are half the height of locker unit 1220. This is so that the interlocking mechanism can still be used to connect them physically and for power.

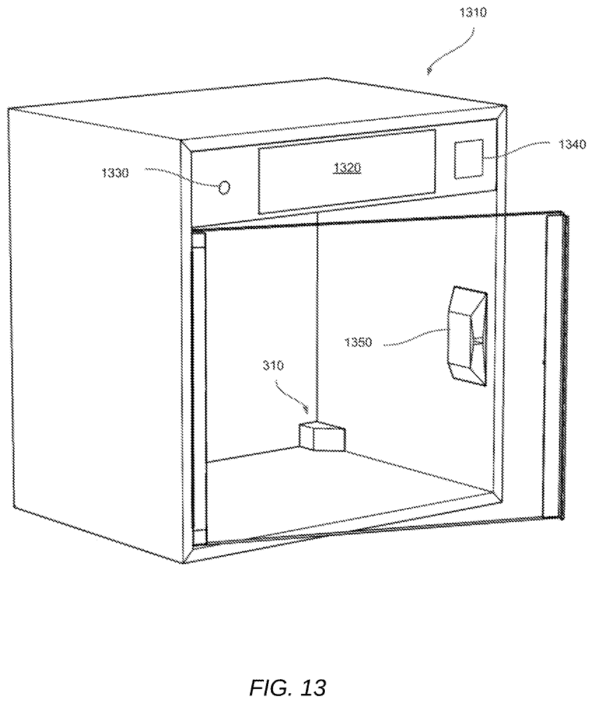

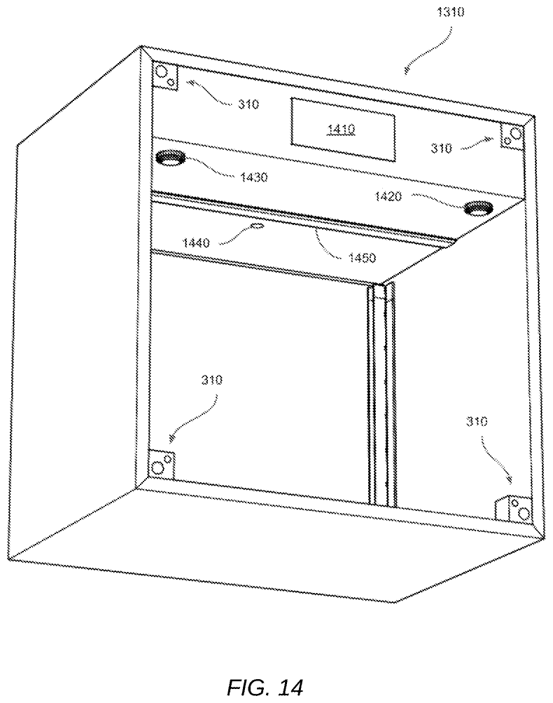

FIG. 13 and FIG. 14 show a detailed view of an exemplary locker unit 1310 with the components highlighted. Each locker unit may have a different set of components depending on the selected configuration.

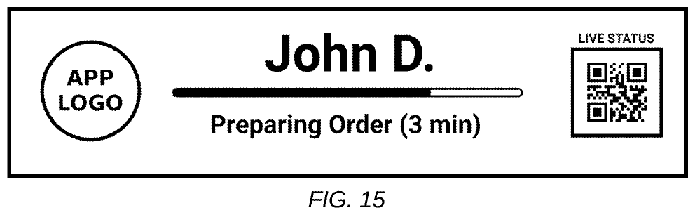

In an exemplary embodiment, the locker unit 1310 includes a front display 1320 to show information about the order to the user. The locker unit receives information about the order (customer name, order number, app used to place the order) from the cloud control software 810. This display can also show a QR code for the user to retrieve the order using the phone. FIG. 15 shows a screenshot of an exemplary user interface of the front display with the logo of the App where the order was placed from, the name of the user that placed the order, the order status (preparing) as well as the QR to check the status from a mobile device and open the locker once the order is ready.

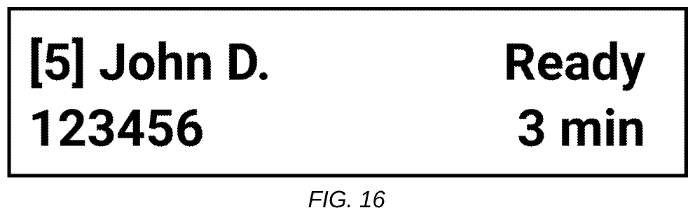

In an exemplary embodiment, the locker unit 1310 includes a back display 1410 to show information about the order to the operator (cook, store attendant). The operator will use this information to know what order to place in which locker unit (from the rear). FIG. 16 shows a screenshot of an exemplary user interface of the back display displaying the locker unit number, order number, the name of the user that placed the order, and the order status (ready).

In an exemplary embodiment, the locker unit includes a physical push button 1420 that the operator can use to indicate that the order is ready for pickup. Once the order is marked as ready a text message or notification is sent to the customer or delivery person. This physical button provides an easy method to indicate the order is complete in environments like a kitchen, where using a touch screen or tablet device can be hard.

In an exemplary embodiment, the locker unit 1310 includes a second physical push button 1430 that the operator can use to cycle through the available orders in the queue to assign to the locker unit or to free the locker unit.

In an exemplary embodiment, the locker unit 1310 contains a down-facing camera 1440 to detect when a package is placed inside. This can be used to make the locker unit available for the next order once the package has been picked up.

In an exemplary embodiment, the locker unit 1310 contains a front-facing camera 1330 used as an additional level of security when the package inside requires extra verification of the user picking up the package. For example, if the package inside was an item that requires age verification, the user picking up could present an ID to the front-facing camera, which will compare the ID to match the person to ensure age requirements.

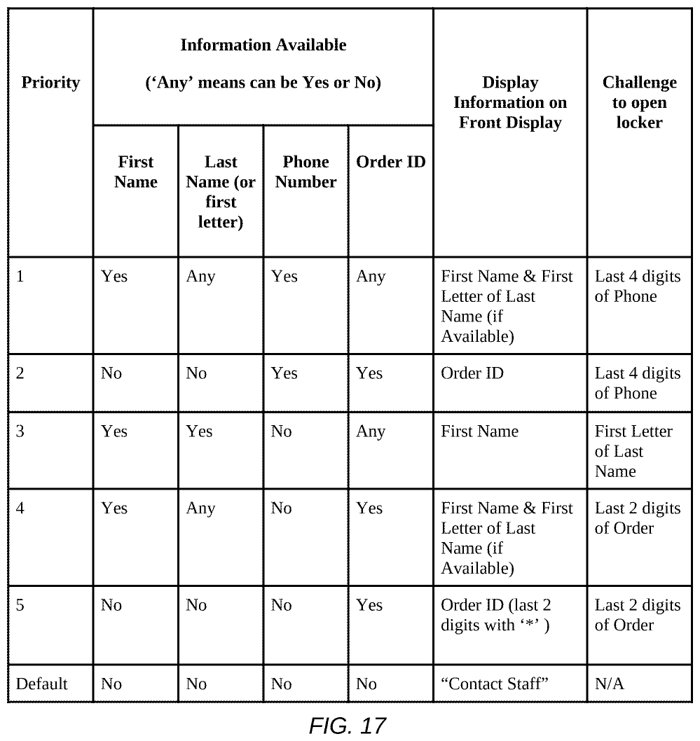

The end-user opens the locker unit via a text message, email, or by entering some basic information about the order, from a mobile device. In the case of receiving a text message or email, the link provided is enough for the user to open the locker. However, in the case where the user opens the locker by scanning the front screen QR code, additional information has to be provided to confirm the user identity. FIG. 17 shows the different alternatives of what information is displayed to the user on the front display and what information is used for security verification. For example, if there was an order for “John D” with no phone number, the locker unit could display “John” in the front display and the delivery person would have to enter “D” before opening the locker (row 3 on the table of FIG. 17).

Multiple locker units can be opened at the same time because each has all the necessary information and input/output required to operate, without needing a central computing station.

In all these embodiments, the front display 1320, the back display 1410, the primary 1420 and secondary 1430 push buttons, the front-facing 1330 and down-facing 1440 cameras, as well as other parts like an RFID card reader 1340, an electromagnetic door latch 1350, a multi-color LED rail 1450, and a heating/cooling element are all connected to the local computing device 210 on each locker unit 1310.

This written description uses examples to disclose the embodiments and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. It is to be understood that components from one embodiment may be combined with components from another embodiment.

We claim:

1. A distributed smart locker system comprising a plurality of locker units in a locker cluster, each locker unit in the locker cluster comprising:
a front panel with a set of inputs for an end user to retrieve an at least one item stored in the locker unit;
a back panel with a set of outputs for an operator to place the at least one item in the locker unit; and
a computing device with a processor, memory, storage, and wireless networking capability.

2. The distributed smart locker system of claim 1 wherein each locker unit comprises:
a power supply for connecting the locker unit to an electrical outlet, whereby the locker unit can distribute power to other locker units in the locker cluster, thereby functioning as a power source; and
an attachment mechanism to attach the locker unit to a power source locker unit or to another locker unit in the locker cluster, thereby forming a power link.

3. The distributed smart locker system of claim 1 wherein the locker units are configured to be physically interconnected in the locker cluster such that a locker unit can be added and removed from the locker cluster without affecting other locker units in the locker cluster.

4. The distributed smart locker system of claim 3 wherein the locker units within a locker cluster are of different sizes.

5. The distributed smart locker system of claim 3 wherein the back panel of each locker unit comprises a plurality of anchor points for interlocking locker units to form the locker cluster;
wherein the anchor points serve as both mechanical and electrical connections.

6. The distributed smart locker system of claim 5 wherein the anchor points interconnect via an interlocking mechanism that transmits power and serves as mechanical fastening.

7. The distributed smart locker system of claim 1 wherein the front panel of the locker unit further comprises a front display displaying information about an order to the end user for easy identification and item pick up.

8. The distributed smart locker system of claim 7 wherein the back panel of the locker unit further comprises a back display displaying information about the order to the operator for easy identification of which order goes in which locker unit.

9. The distributed smart locker system of claim 7 wherein the front display, in operative communication with the computing device, is configured to:
display a first portion of order information allowing the end user to identify which locker unit is assigned to the order; and
present a visual challenge to the end user, the visual challenge comprising a second portion of the order information.

10. The distributed smart locker system of claim 1 wherein the locker units comprise a physical push button that allows the operator to update a status of the order.

11. The distributed smart locker system of claim 10 wherein the locker units further comprise a secondary physical push button that allows the operator to cycle through available orders in the distributed smart locker system or free the locker unit.

12. The distributed smart locker system of claim 1 wherein the locker units further comprise a down-facing camera that detects when the at least one item has been picked up from the locker.

13. The distributed smart locker system of claim 1 wherein the locker units further comprise a front-facing camera that can verify the end user picking up the at least one item for an extra level of security.
